(19) United States
(12) Patent Application Publication
(10) Pub. No.: US 2015/0358046 A1
(43) Pub. Date: Dec. 10, 2015

(54) RADIO MANAGEMENT

(71) Applicant: GrandiOs Technologies, LLC, Wilmington, DE (US)

(72) Inventor: John Cronin, Bonita Springs, FL (US)

(21) Appl. No.: 14/624,067

(22) Filed: Feb. 17, 2015

Related U.S. Application Data
(60) Provisional application No. 62/007,876, filed on Jun. 4, 2014.

(51) Int. Cl. H04B 1/401; H04B 1/3827

(52) U.S. Cl. CPC H04B 1/401; H04B 1/3827

(57) ABSTRACT

Methods and systems for providing a radio management center are provided. A set of radio settings may be stored in memory of a mobile device that includes a plurality of radios. The received set of radio settings may identify one or more parameters for evaluating the radios. A communication may be received via a user interface as inputted by a user of the mobile device. Further, one or more radio channels may be detected as being available for use by the mobile device. The set of radio settings may be applied to the detected radio channels so that each of the detected radio channels are evaluated based on the identified parameters. One of the detected radio channels may be based on the parameter-based evaluation. It may be determined which of the plurality of radios corresponds to the selected radio channel, and the communication may be sent via the determined radio.

### CROSS-REFERENCE TO RELATED APPLICATIONS

The present application claims the priority benefit of U.S. provisional application No. 62/007,876 filed Jun. 4, 2014 and entitled “Radio Management,” which is hereby incorporated by reference.

### BACKGROUND OF THE INVENTION

1. Field of the Invention

The present invention generally relates to mobile applications operable on mobile devices. More specifically, the present invention relates to a radio management system on mobile devices.

2. Description of the Related Art

Presently available mobile devices have a variety of different types of radios. Such radio types may include those associated with wireless telephones, 4G, WiFi, Bluetooth, GPS, near field communication (NFC), visible light communications (VLC), beacons, etc. A mobile device may have any combination of such radios. Present controls for such radios are generally limited, however, to ON/OFF settings, which may further encompass choice of network.

Such settings that may be available for radios generally fail to consider the status of other radios nor any of the various environmental factors that may affect radios. As such, there are presently no options for integrating or coordinating radios in an intelligent manner. For example, a mobile device may attempt to send an email using a weak 4G signal, despite the availability of a strong WiFi signal. While a user may manually switch a mobile device to WiFi mode or set a mobile device to recognize a certain WiFi network, there are currently no mechanisms for automatic radio management or coordination.

Reliability, speed, cost-effectiveness, power consumption, security (including use of virtual private network (VPN)), and other characteristics of communications made via radio may relate to various radio variables (e.g., signal strength) that may change from moment to moment. Moreover, the user may value different parameters in different situations. There are, however, no presently available ways to manage or coordinate multiple radios that may be responsive to changes occurring in real-time.

There is, therefore, a need in the art for improved systems and methods of radio management for mobile devices.

### SUMMARY OF THE CLAIMED INVENTION

Embodiments of the present invention provide methods and systems for providing a radio management center. A set of radio settings may be stored in memory of a mobile device that includes a plurality of radios. The received set of radio settings may identify one or more parameters for evaluating the radios. A communication may be received via a user interface as inputted by a user of the mobile device. Further, one or more radio channels may be detected as being available for use by the mobile device. The set of radio settings may be applied to the detected radio channels so that each of the detected radio channels are evaluated based on the identified parameters. One of the detected radio channels may be based on the parameter-based evaluation. It may be determined which of the plurality of radios corresponds to the selected radio channel, and the communication may be sent via the determined radio.

Methods for providing a radio management center may include storing a set of radio settings in memory of a mobile device that has a plurality of radios. The received set of radio settings may identify one or more parameters for evaluating the radios. Methods may further include receiving a communication via a user interface as inputted by a user of the mobile device, detecting one or more radio channels that are available for use by the mobile device, applying the set of radio settings to the detected radio channels so that each of the detected radio channels are evaluated based on the identified parameters, selecting one of the detected radio channels based on the parameter-based evaluation, determining which of the plurality of radios corresponds to the selected radio channel, and sending the communication via the determined radio.

Various embodiments may further include systems for providing a radio management center. Such systems may include a plurality of radios that detect one or more radio channels that are available for use by the mobile device, memory that stores a set of radio settings that identify one or more parameters for evaluating the radios, a user interface that receives a communication inputted by a user of the mobile device, a processor that executes instructions to apply the set of radio settings to the detected radio channels so that each of the detected radio channels are evaluated based on the identified parameters, to select one of the detected radio channels based on the parameter-based evaluation, and to determine which of the plurality of radios corresponds to the selected radio channel. The communication may then be sent via the determined radio.

Embodiments of the present invention may further include non-transitory computer-readable storage media, having embodied thereon a program executable by a processor to perform methods for providing a radio management center as described herein.

### BRIEF DESCRIPTION OF THE FIGURES

FIG. 1 illustrates an exemplary network environment in which a system for providing a radio management center may be implemented.

FIG. 2 is a diagram illustrating exemplary settings on a mobile device that may be used with a system for providing a radio management center.

FIG. 3 is a flowchart illustrating an exemplary user interface menu that may be used with a system for providing a radio management center.

FIG. 4 illustrates exemplary polling settings on a mobile device that may be used with a system for providing a radio management center.

FIG. 5 illustrates exemplary detailed settings on a mobile device that may be used with a system for providing a radio management center.

FIG. 6 illustrates exemplary speed settings that may be used in a system for providing a radio management center.

FIG. 7 illustrates additional exemplary detailed settings that may be used in a system for providing a radio management center.

FIG. 8 is a flowchart illustrating an exemplary method for providing a radio management center.

FIG. 9 illustrates a mobile device architecture that may be utilized to implement the various features and processes described herein.

### DETAILED DESCRIPTION

Embodiments of the present invention provide methods and systems for providing a radio management center. A set of radio settings may be stored in memory of a mobile device that includes a plurality of radios. The received set of radio settings may identify one or more parameters for evaluating the radios. A communication may be received via a user interface as inputted by a user of the mobile device. Further, one or more radio channels may be detected as being available for use by the mobile device. The set of radio settings may be applied to the detected radio channels so that each of the detected radio channels are evaluated based on the identified parameters. One of the detected radio channels may be based on the parameter-based evaluation. It may be determined which of the plurality of radios corresponds to the selected radio channel, and the communication may be sent via the determined radio.

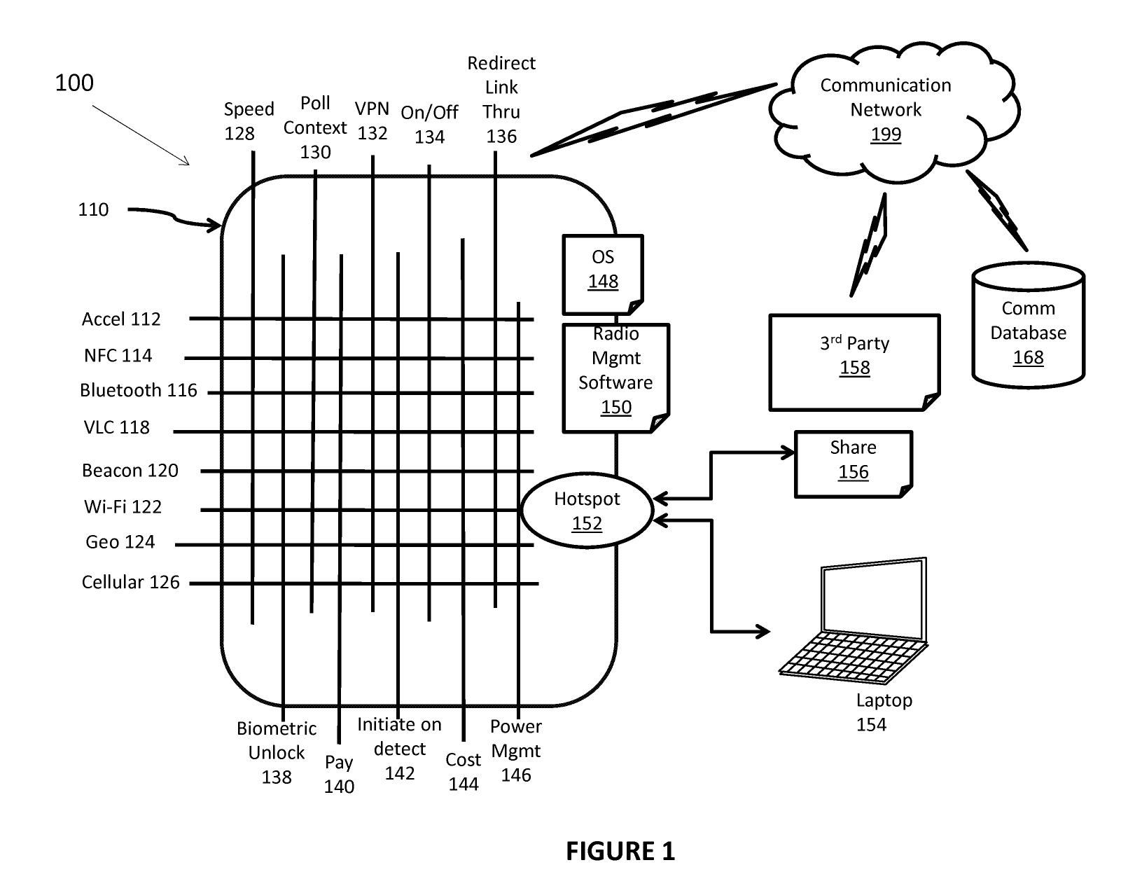

FIG. 1 illustrates an exemplary network environment 100 in which a system for providing a radio management center may be implemented. Network environment 100 may include a user devices 110 (which may include accelerometer 112, NFC 114, Bluetooth 116, VLC 118, beacon 120, WiFi 122, geolocation 124 cellular 126, speed 128, poll context 130, VPN 132, ON/OFF 134, redirect link thru 136, biometric lock/unlock 138, pay 140, initiate on detect 142, cost 144, power management 146, OS 148, radio management software 150, and hotspot 152), laptop 154, share 156 (e.g., any device that allows for sharing), 3rd party 158, and communication database 168. The different parts of network environment 100 may communication via communication network 199.

Users may use any number of different electronic user devices 110, such as mobile phones, smartphones, personal digital assistants (PDAs), portable computing devices (e.g., laptop, netbook, tablets), handheld computing devices, or any other type of computing device capable of communicating over communication network 199. User devices 110 may also be configured to access data from other storage media, such as memory cards or disk drives as may be appropriate in the case of downloaded services. User device 110 may include standard hardware computing components such as network and media interfaces, non-transitory computer-readable storage (memory), and processors for executing instructions that may be stored in memory.

Communication antennas and other communication modules of user device 110 may allow user device 110 to communicate wirelessly over the communication network 199. The specific design and implementation of the communication systems of the user device 110 can depend on the communication network(s) or medium(s) over which the device is intended to operate. As used herein, the generic term “radio” may refer to any of accelerometer 112, NFC 114, Bluetooth 116, VLC 118, beacon 120, WiFi 122, geolocation 124, or cellular 126.

Accelerometer 112 can facilitate orientation determinations, motion sensing (e.g., bumps, vibration), image stabilization, and other functions. As such, accelerometer 112 may include or be associated with any number of gyros, free-fall sensors, motion sensors, and other sensors known in the art. In addition, communications may also occur using NFC 114, Bluetooth 116, VLC 118, beacon 120, WiFi 122, geolocation 124, cellular 126, and/or any other type of radio frequency communication network known in the art. Such radios may have different ranges to which each radio can communicate. For example, accelerometers may have a very short range (e.g., touching distance), while geolocation 124 may have a very wide range (e.g., to satellites).

In some instances, the location of a Wi-Fi hotspot received by a user device may be used to determine an approximate location. Alternatively, geolocation 124 may include any system known in the art for determining the location of a handheld device. Such systems may include GPS and/or assisted GPS, or may use information from local cell towers to triangulate or otherwise determine location information for a handheld device.

With respect to cellular 126, a device may include wireless communication subsystems designed to operate over a global system for mobile communications (GSM) network, a general packet radio service (GPRS) network, an enhanced data GSM environment (EDGE) network, 802.x communication networks (e.g., WiFi, WiMax, or 3G networks), and code division multiple access (CDMA) networks.

A variety of different functions may be used in conjunction with each of the radios described herein. Such functions may be enabled or disabled for each radio via settings, and may include speed 128, poll context 130 (e.g., whether the radio be polled), VPN 132 (e.g., whether a VPN should be connected when using the radio), ON/OFF 134, redirect link thru 136 (e.g., whether to allow for radio switching via links), biometric lock/unlock 138, pay 140 (e.g., whether the radio network is free or requires payment), initiate on detect 142 (e.g., allow for initiation of a designated app on detection of a particular radio), cost 144, and power management 146.

Biometric lock/unlock 138 may allow for additional security by requiring biometric input before enabling or using a radio to perform a particular function. Many user devices 110 having such biometric components may already provide their users with the ability to input, authenticate, and store their own biometrics (e.g., via a button on the device 110).

Pay 140 may determine whether use of the radio management system is free or incurs a fee. Initiate on detect 142 allows for immediate opening of an app when a beacon is detected. In addition, a cost management 144 and power management 146 systems may be present.

Operating system (OS) 148 is a collection of software that manages computer hardware resources and provides common services for computer programs, including applications. The operating system 148 is an essential component of the system software in a computer system. Applications are usually developed for a specific operating system 148 and therefore rely on the associated operating system 148 to perform its functions. For hardware functions such as input and output and memory allocation, the operating system 148 acts as an intermediary between applications and the computer hardware. Although application code is usually executed directly by the hardware, applications may frequently make a system call to an OS function or be interrupted by it. Operating systems 148 can be found on almost any device with computing or processing ability. Examples of popular modern operating systems include Android, BSD, iOS, Linux, OS X, QNX, Microsoft Windows, Windows Phone, and IBM z/OS. Most of these (except Windows, Windows Phone and z/OS) may share roots in UNIX.

Radio management may be based, at least in part, on settings of operating system 148 that specifically pertain to the radios and management thereof. Various options or preferences allow the user to designate certain parameters and priorities with respect to how certain operating system functions are performed. Once these settings are set, the radio center software 150 may perform various functions automatically and in accordance with the user-designated radio settings. Radio management software 150 may provide an integrated interface on the user device 110, which allows the user to easily do all radio as needed at multiple radio networks.

User device 110 may be connected to laptop 154 via tethering or other connection (e.g., WiFi) to hotspot 152 or Bluetooth 116. As such, share 156 may allow user device 110 to share any type of radio with other devices (e.g., laptop 154).

Radio cart network 152 may be based on any information provided by multiple user devices 140 as allowed by users who wish to share their radio information with their friends, contacts, and/or social networks. Each user may set their user device 140 to send radio information as requested, in real-time, or automatically to radio cart network 152. In some instances, the information may be saved to radio cart database 156 associated with radio cart network 152. The aggregated information from multiple user devices 140 may be used to predict radio purchases, make recommendations, and aid in determining radio rules. The radio information from friends, contacts, or social networks may be browsed by the user, as well as aggregated to identify radio trends.

3rd party 158 may include any party that may participate in the radio transaction. Such third party networks 160 may include any user, developer, or service provider who may participate in the radio ecosystem. Such third party networks 158 may need or find it useful to obtain information on various users and their habits and preferences with respect to radio.

Communication database 168 may include any type of database and may be associated with any server or other computing device known in the art, including standard hardware computing components such as network and media interfaces, non-transitory computer-readable storage (memory), and processors for executing instructions or accessing information that may be stored in memory. The functionalities of multiple servers may be integrated into a single server. Alternatively, different functionalities may be allocated among multiple servers, which may be located remotely from each other and communicate over the cloud. Any of the aforementioned servers (or an integrated server) may take on certain client-side, cache, or proxy server characteristics. These characteristics may depend on the particular network placement of the server or certain configurations of the server.

Communication network 199 may be a local, proprietary network (e.g., an intranet) and/or may be a part of a larger wide-area network. Communication network 199 may comprise a variety of connected computers that may provide a set of network-based services. Such network service may be provided by real server hardware and/or by virtual hardware as simulated by software running on one or more real machines. Such virtual servers may not physically exist and can therefore be moved around and scaled up (or down) on the fly without affecting end-users (e.g., like a cloud).

Communication network 199 allow for communication between the user device 140, radio networks 144 and 148, radio cart network 152, and third party networks 160 via various communication paths or channels. Such paths or channels may include any type of data communication link known in the art, including TCP/IP connections and Internet connections via Wi-Fi, Bluetooth, UMTS, etc. In that regard, communications network 199 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider.

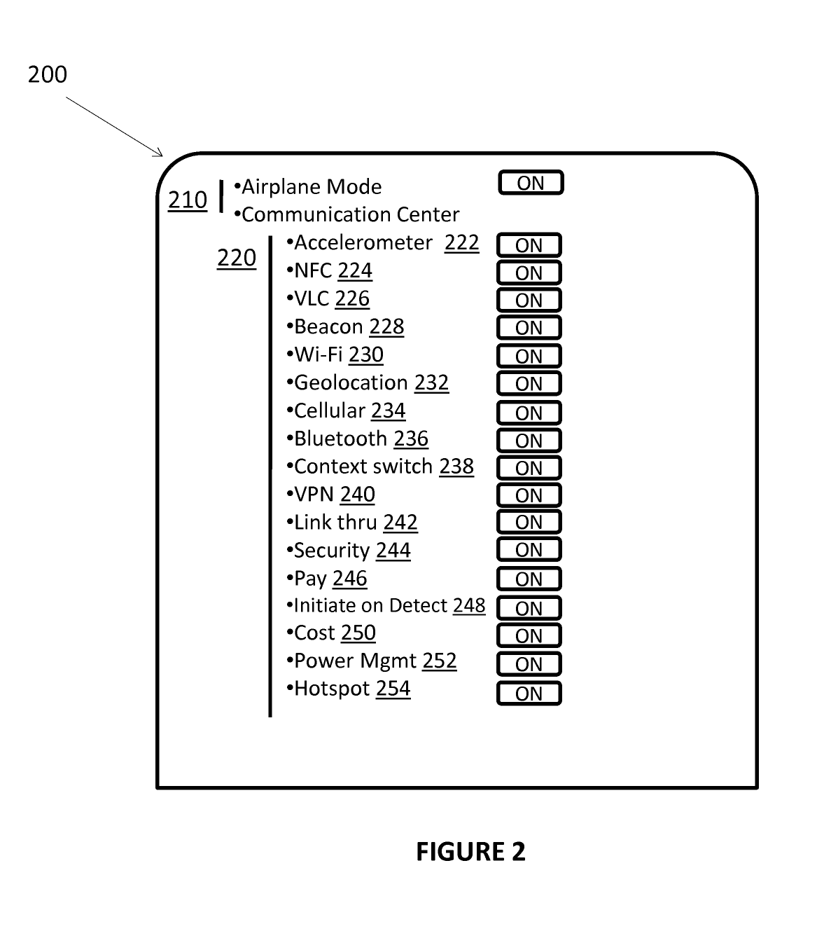

FIG. 2 is a diagram illustrating exemplary settings 200 on a mobile device that may be used with a system for providing a radio management center. Such settings may include generic settings 210, such as airplane mode or communication center. Additional settings 220 specific to radio may include accelerometer 222, NFC 224, VLC 226, beacon 228, WiFi 230, geolocation 232, cellular 234 (e.g., 3G, 4G), Bluetooth 236, context switch 238 (e.g., polling through radios and switching based on, inter alia, signal availability and speed), VPN 240, link thru 242 (e.g., taking a link from a broadcaster and executing that link on the fly), security 244 (e.g., whether third parties can view settings remotely), pay 246 (e.g., considering cost of connections), initiate on detect 248 (e.g., triggering an app on detection of a communication medium), cost 250 (e.g., considering actual costs based on, inter alia, time of connection), power management 252 (e.g., considering amount of power used), and hotspot 254.

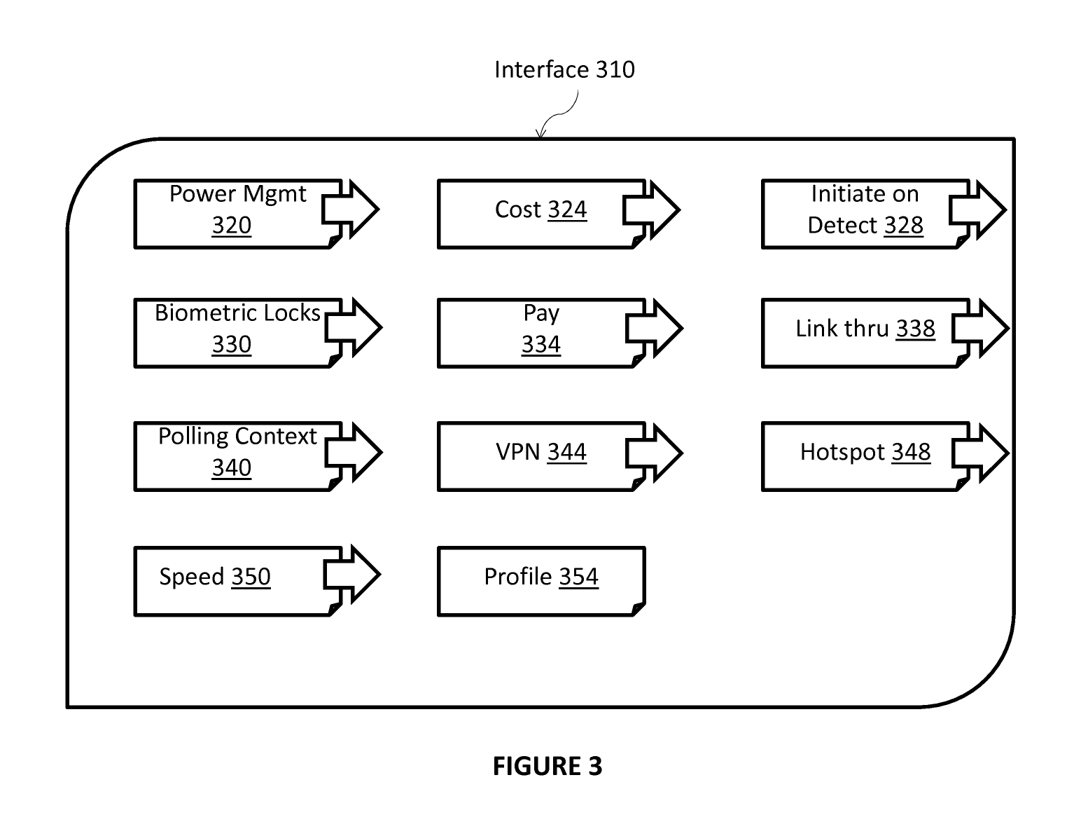

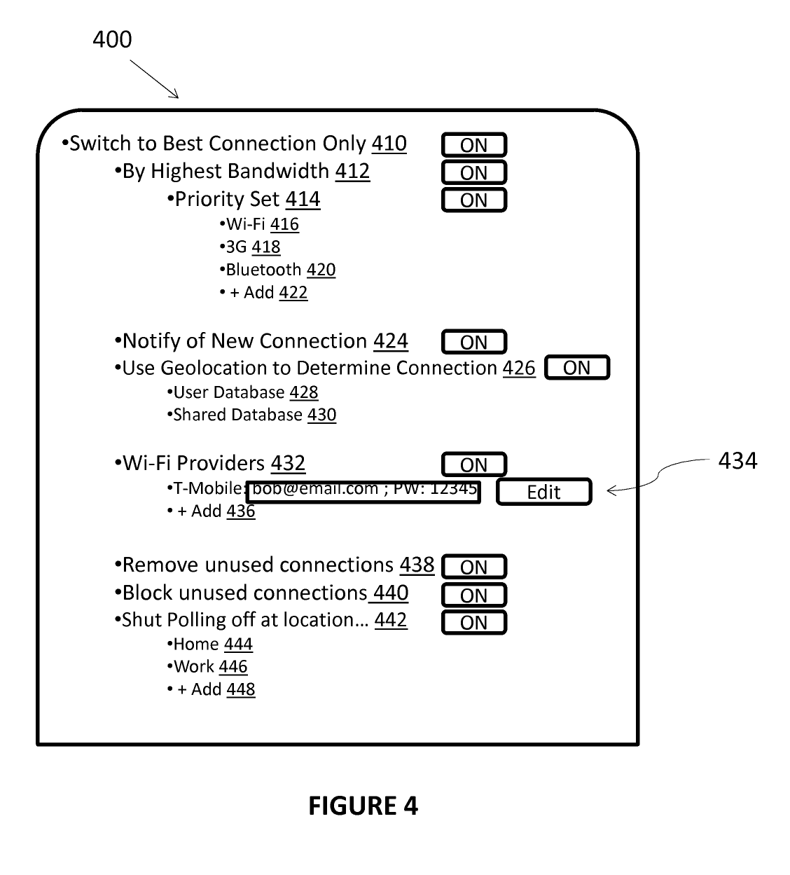

FIG. 3 is a flowchart illustrating an exemplary user interface menu 310 that may be used with a system for providing a radio management center. Such a user interface 310 may lead to more detailed submenus as discussed herein with respect to FIGS. 4-7. Generally, such a user interface 310 may include submenus related to power management 320, cost 324, initiate on detect 328, biometric locks 330, pay 334, link thru 338, polling context 340, VPN 344, speed 350, profile 354, and hotspot 348. Selection of one of these options may lead to a submenu described below.

FIG. 4 illustrates exemplary polling settings 400 on a mobile device that may be used with a system for providing a radio management center. Such polling settings 400 allow for polling of multiple radios and selecting one of the polled radios based on one or more factors. Options available in polling settings 400 may include switch to best connection only 410, which may include sub-options by highest bandwidth 412 and priority set 414 for WiFi 416, 3G 418, Bluetooth 420, and Add 422. Polling may occur, thereby determining best connection (e.g., based on signal strength, speed, bandwidth, etc.). The user may further set priority as to preference regarding type of radio to be used when available.

The user may also select the option to be notified of any new connection 424, which may be based on geolocation to determine connection 426, user database 428, and shared database 430. For example, if VLC is found, the user may receive a notification as to the same. Alternatively, the user may enable an option to use geolocation to determine connection 426 such that when the user device 110 is determined to be in a particular location (e.g, local Starbucks), a connection may be automatically made to the Starbucks WiFi. Such locations may be saved locally to the user device or in a remote, shared database.

The user may also select the types of WiFi providers 432 (e.g., T-mobile account: bob@email.com, pw: 12345, or add another account 436). Additional options may include removing an unused connection 438, block unused connection 440, and shut polling off at location 442 for home 444, work 446, and add 448.

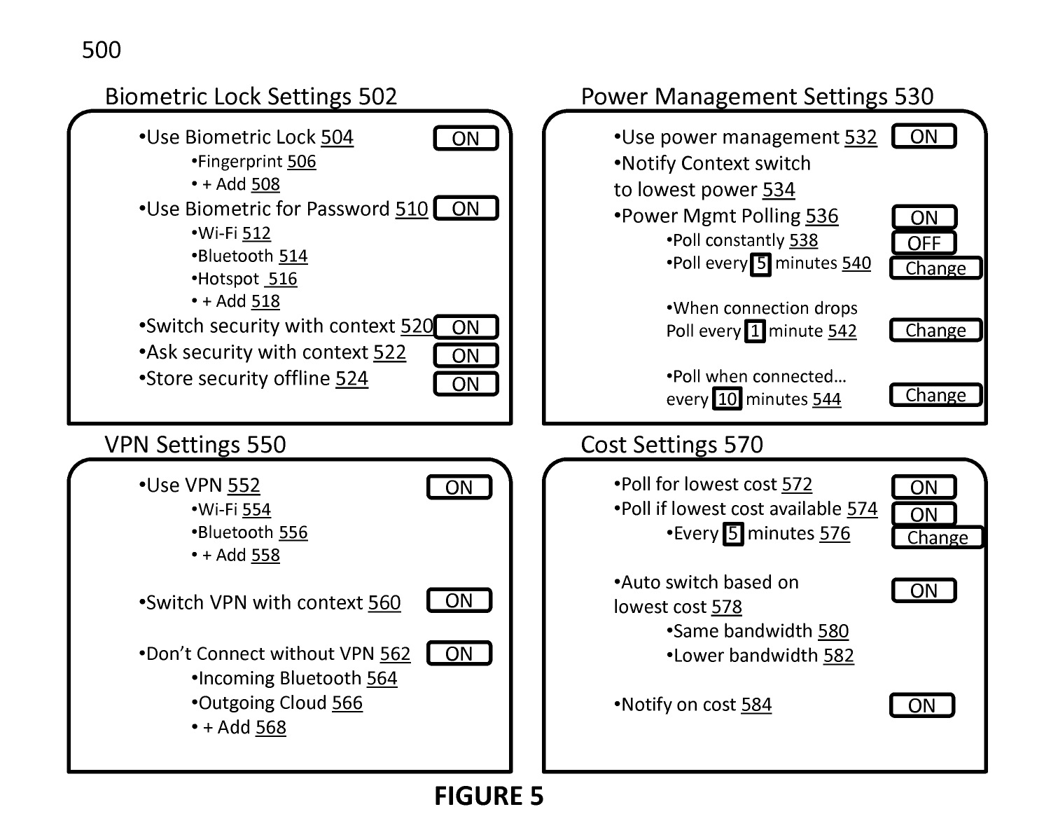

FIG. 5 illustrates exemplary detailed settings 500 on a mobile device that may be used with a system for providing a radio management center. Such settings 500 may pertain to biometric lock settings 502, power management settings 530, VPN settings 550, and cost settings 570.

Biometric lock settings 502 allow for biometric security measures to be associated with use of certain radios. Biometric lock settings 502 may include settings for use biometric lock 504, which may include fingerprint 503 or add 508 (e.g, to add other biometrics). In addition, biometric settings 502 may further include use biometric for password 510 for radios such as WiFi 512, Bluetooth 514, hotspot 516, and/or add 518. Such biometric may be stored in memory (e.g., in a table), which serves as a point of comparison when biometric input is received and evaluated for a match. Security settings may be switched with context 520 (e.g., a biometric lock may be used to allow or disallow switching between radio networks), ask security with context 522 (e.g., pop-up window asking for biometric before switching radio networks), as well as store security settings offline 524 (e.g., in shared database).

Power management settings 530 allow for power usage to be considered in relation to use of certain radios. Power management settings 530 may include options to use power management 532, notify context switch to lowest power 534 (e.g., where multiple radios with different power consumption rates are available), and power management polling 536. Such power management polling 536 may further be associated with sub-options to poll constantly 538, poll every _{——} minute(s) 540, when connection drops poll every _{——} minute(s) 542, and poll when connected every _{——} minutes 544.

VPN settings 550 allow for additional security (e.g., in the form of virtual private networks (VPNs)) to be associated with use of certain radios. VPN settings 550 may include options to use VPN 552 (which may include sub-options for WiFi 554, Bluetooth 556, and add 558). Additional options may include switch VPN with context 560 (e.g., allowing VPN to be switched between different radio networks), and don't connect without VPN 562 (which further includes sub-options for incoming Bluetooth 564, outgoing cloud 566, and add 568).

Cost settings 570 allow for consideration of costs associated with use of mobile devices (e.g., minutes plan, data plan, text plan). Data regarding the specific cost structures for the user device may be maintained in a database and used to calculate costs for certain communications and evaluate for each radio network. Such costs may pertain to a standing mobile device plan, as well as temporary or short-term plans (e.g., Boingo hotspots in airports). Such costs may affect the decision of which communication medium (e.g., radio) to use to send communications. Cost settings 570 may include poll for lowest cost 572, poll if lowest cost available 574 (with sub-option every _{——} minute(s) 576), auto switch based on lowest cost 578 (with sub-options for same bandwidth 580 and lower bandwidth 582), and notify on cost 584 (e.g., the user may be presented with different cost estimates and allowed to select a radio network).

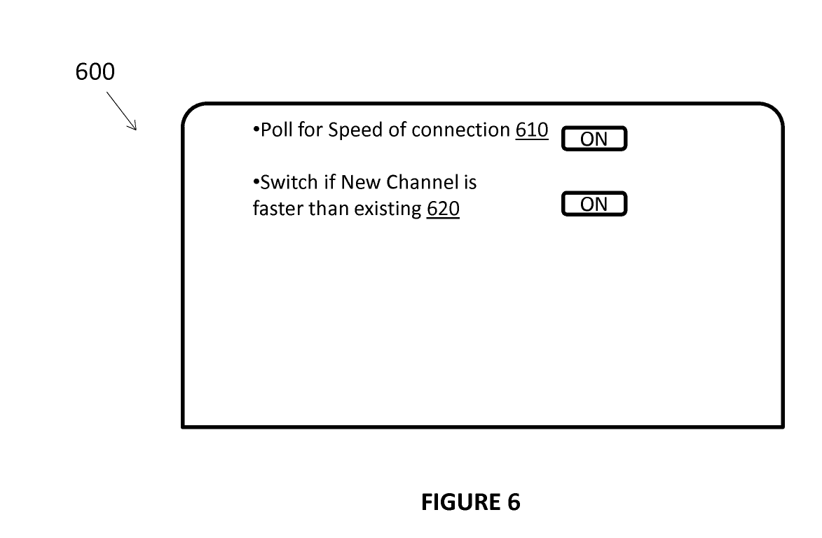

FIG. 6 illustrates exemplary speed settings 600 that may be used in a system for providing a radio management center. Such speed settings 600 allow for speed to be considered in the management decisions regarding radio usage. Speed settings 600 may include options to poll for speed of connection 610 and switch if new channel is faster than existing 620.

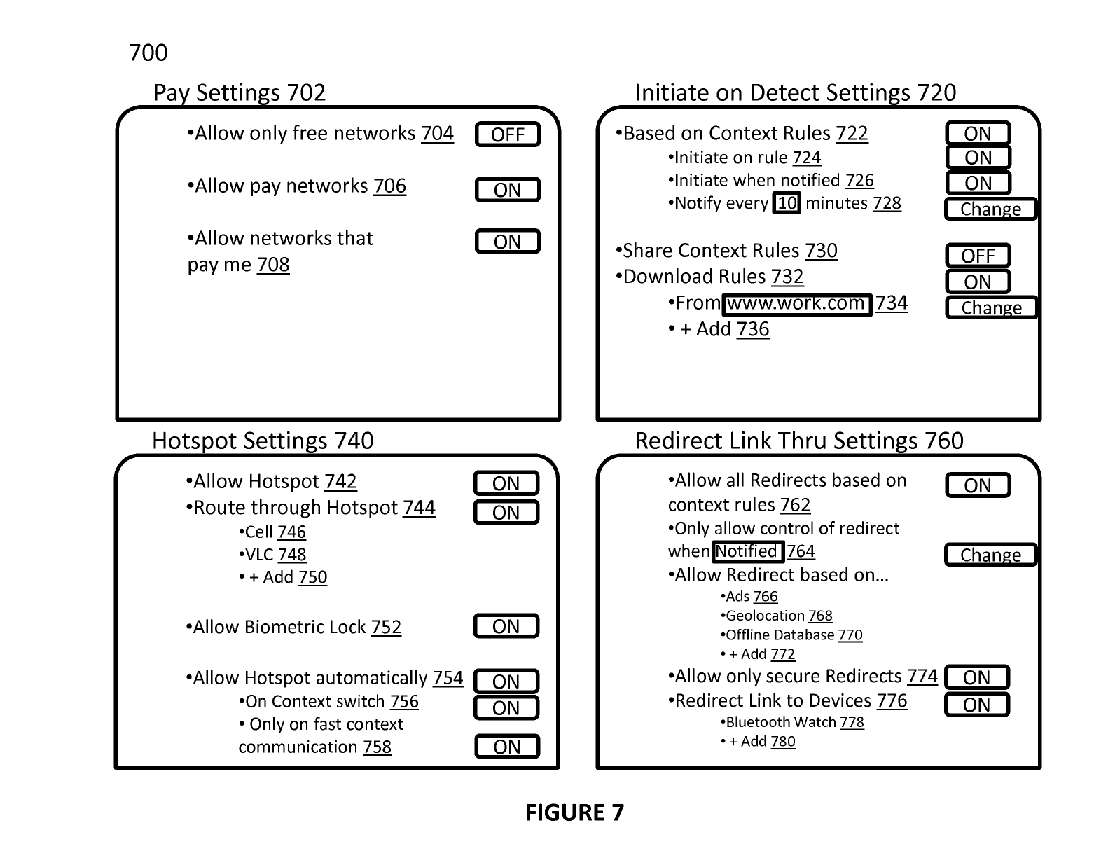

FIG. 7 illustrates additional exemplary detailed settings 700 that may be used in a system for providing a radio management center. Such settings 700 may include pay settings 702, initiate on detect settings 720, hotspot settings 740, and redirect link thru settings 760.

Pay settings 702 allow for consideration of whether certain networks require payment in relation to decisions for managing radio. Such pay settings 702 may include options to allow only free networks 704, allow pay networks 706, and allow networks that pay me 708.

Initiate on detect settings 720 allow for initiation of certain radios based on detection of various contexts. Although a communication channel (e.g., of a specific radio) is initiated based on one or more context rules, the contexts may change. As such, the initiate on detect settings 720 allow for the user to be notified regarding the change, which may further be associated with the switch to another radio selected based on the changed contexts and various context rules. Such initiate on detect settings 720 may include options for being based on context rules 722 (which may include sub-options to initiate on rule 724, initiate when notified 726, and notify every _{——} minute(s) 728), share context rules 730, and download rules 732 (which may include sub-options regarding from [www.work.com] 734 and add 736.

Hotspot settings 740 allow for use of certain radios in relation to hotspots. Such hotspot settings 740 may include allow hotspot 742, route through hotspot 744 (which may include cell 746, VLC 748, and add 750), allow biometric lock 752 (e.g., require biometric input before the user device will use the hotspot), and allow hotspot automatically 754 (which may include on context switch 756 and only on fast context communication 758).

Redirect link thru settings 760 allow for redirection via links in relation to usage of certain radios. For example, VLC may be broadcasting a link to turn on an app on the mobile device. Whether such link is allowed may depend on the redirect link thru settings 760, which may include options to allow all redirects based on context rules 762, only allow control of direct when [notified] 764, allow redirect based on various factors (e.g., ads 766, geolocation 768, offline database 770, and add 772), allow only secure redirects 774, and redirect link to devices 776 (which may include sub-options for Bluetooth watch 778 and add 780).

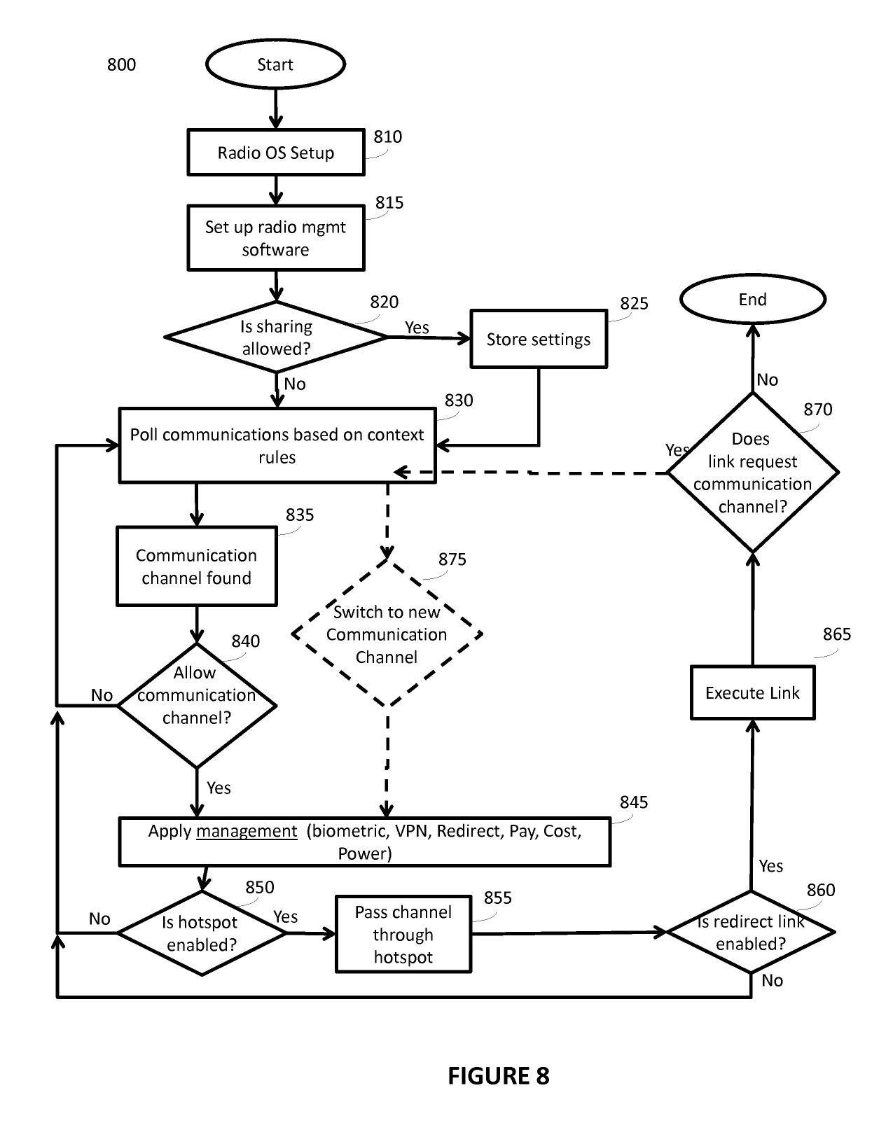

FIG. 8 is a flowchart illustrating an exemplary method 800 for providing a radio management center. In step 810, the radio operating system settings may be set up. In step 815, the radio management software may be set up.

In step 820, it may be determined whether sharing is allowed. If so, the settings may be stored to a shared database in step 825. If not, the method proceeds to step 830, in which communication channels (each associated with different radios) may be polled based on various context rules.

In step 835, a communication channel may be found. In this regard, it may be determined which radio channels may be available and subsequently, which of the available channels may best corresponds to the context rules.

In step 840, it may be determined whether the communication channel is allowed. If not, the method returns to step 830 to poll for another communication channel. If the communication channel is allowed, the method may proceed to step 845, in which management settings may be applied. Such management settings may pertain to any combination and use of biometrics, VON, redirection, pay, cost, and power.

In step 845, it may be determined whether a hotspot is enabled. If not, the method may return to step 830 for additional polling. If a hotspot is indeed enabled, the channel may be passed through the hotspot in step 855.

In step 860, it may be determined whether redirection of links may be enabled. If not, the method returns to step 830 for additional polling. Alternative, if redirection is enabled, the method may proceed to step 865 for execution of the link.

In step 870, it may be determined whether the link requests a particular communication channel. If not, the method may end. If the link does requests a particular communication channel, the method may return to step 830.

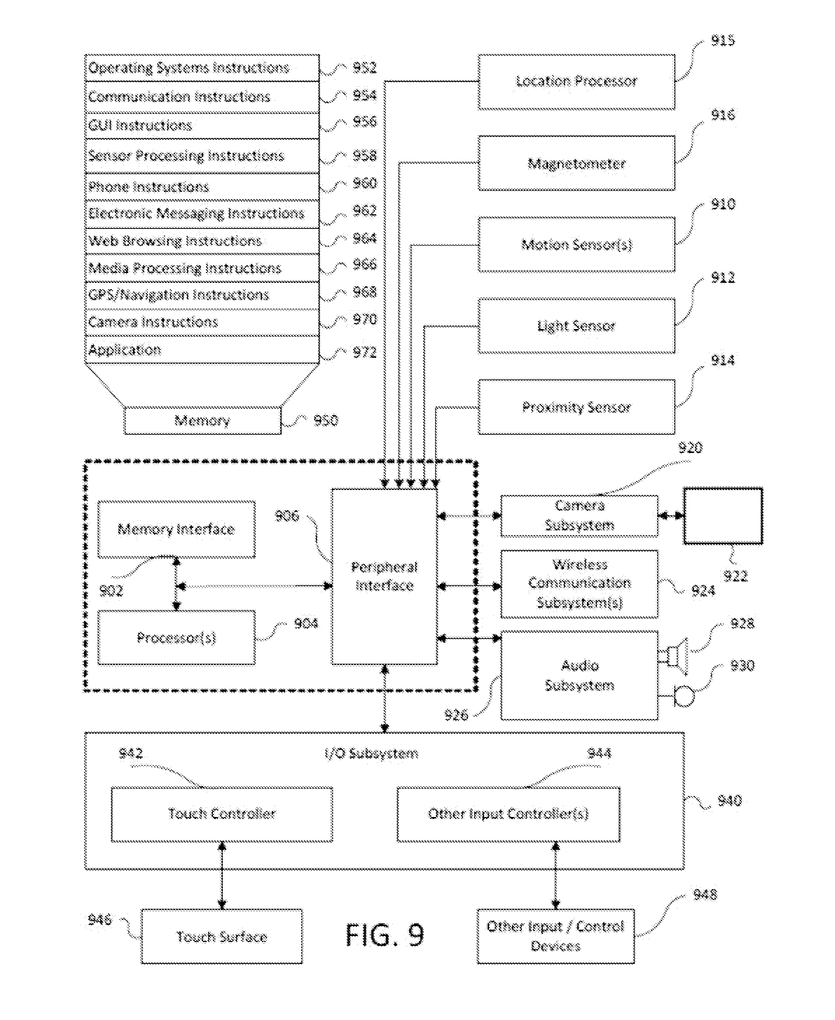

FIG. 9 illustrates a mobile device architecture that may be utilized to implement the various features and processes described herein. Architecture 900 can be implemented in any number of portable devices including but not limited to smart phones, electronic tablets, and gaming devices. Architecture 900 as illustrated in FIG. 9 includes memory interface 902, processors 904, and peripheral interface 906. Memory interface 902, processors 904 and peripherals interface 906 can be separate components or can be integrated as a part of one or more integrated circuits. The various components can be coupled by one or more communication buses or signal lines.

Processors 904 as illustrated in FIG. 9 are meant to be inclusive of data processors, image processors, central processing unit, or any variety of multi-core processing devices. Any variety of sensors, external devices, and external subsystems can be coupled to peripherals interface 906 to facilitate any number of functionalities within the architecture 900 of the exemplar mobile device. For example, motion sensor 910, light sensor 912, and proximity sensor 914 can be coupled to peripherals interface 906 to facilitate orientation, lighting, and proximity functions of the mobile device. For example, light sensor 912 could be utilized to facilitate adjusting the brightness of touch surface 946. Motion sensor 910, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 906, such as a temperature sensor, a biometric sensor, or other sensing device to facilitate corresponding functionalities. Location processor 915 (e.g., a global positioning transceiver) can be coupled to peripherals interface 906 to allow for generation of geo-location data thereby facilitating geo-positioning. An electronic magnetometer 916 such as an integrated circuit chip could in turn be connected to peripherals interface 906 to provide data related to the direction of true magnetic North whereby the mobile device could enjoy compass or directional functionality. Camera subsystem 920 and an optical sensor 922 such as a charged coupled device (CCD) or a complementary metal-oxide semiconductor (CMOS) optical sensor can facilitate camera functions such as recording photographs and video clips.

Communication functionality can be facilitated through one or more communication subsystems 924, which may include one or more wireless communication subsystems. Wireless communication subsystems 924 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 924 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 924 may include hosting protocols such that the device may be configured as a base station for other wireless devices. Communication subsystems can also allow the device to synchronize with a host device using one or more protocols such as TCP/IP, HTTP, or UDP.

Audio subsystem 926 can be coupled to a speaker 928 and one or more microphones 930 to facilitate voice-enabled functions. These functions might include voice recognition, voice replication, or digital recording. Audio subsystem 926 in conjunction may also encompass traditional telephony functions.

I/O subsystem 940 may include touch controller 942 and/or other input controller(s) 944. Touch controller 942 can be coupled to a touch surface 946. Touch surface 946 and touch controller 942 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 946 may likewise be utilized. In one implementation, touch surface 946 can display virtual or soft buttons and a virtual keyboard, which can be used as an input/output device by the user.

Other input controllers 944 can be coupled to other input/control devices 948 such as one or more buttons, rocker switches, thumb-wheels, infrared ports, USB ports, and/or a pointer device such as a stylus. The one or more buttons (not shown) can include an up/down button for volume control of speaker 928 and/or microphone 930. In some implementations, device 900 can include the functionality of an audio and/or video playback or recording device and may include a pin connector for tethering to other devices.

Memory interface 902 can be coupled to memory 950. Memory 950 can include high-speed random access memory or non-volatile memory such as magnetic disk storage devices, optical storage devices, or flash memory. Memory 950 can store operating system 952, such as Darwin, RTXC, LINUX, UNIX, OS X, ANDROID, WINDOWS, or an embedded operating system such as VXWorks. Operating system 952 may include instructions for handling basic system services and for performing hardware dependent tasks. In some implementations, operating system 952 can include a kernel.

Memory 950 may also store communication instructions 954 to facilitate communicating with other mobile computing devices or servers. Communication instructions 954 can also be used to select an operational mode or communication medium for use by the device based on a geographic location, which could be obtained by the GPS/Navigation instructions 968. Memory 950 may include graphical user interface instructions 956 to facilitate graphic user interface processing such as the generation of an interface; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes, camera instructions 970 to facilitate camera-related processes and functions; and instructions 972 for any other application that may be operating on or in conjunction with the mobile computing device. Memory 950 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 950 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer may employ to access functions supporting the API. In some implementations, an API call can report to an application the capabilities of a device running the application, such as input capability, output capability, processing capability, power capability, and communications capability.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

1. A method for providing a radio management center, the method comprising:
storing a set of radio settings in memory of a mobile device, the mobile device including a plurality of radios, wherein the stored set of radio settings identifies one or more parameters for evaluating the plurality of radios;
receiving a communication via a user interface of the mobile device;
detecting a plurality of radio channels through which the mobile device can transmit data; and
executing instructions stored in memory, wherein execution of the instructions by a processor:
applies the stored set of radio settings to the plurality of detected radio channels,
generates a plurality of evaluations associated with the plurality of detected radio channels, wherein each evaluation of the plurality of evaluations assesses each radio channel of the plurality of detected radio channels based on at least a subset of the one or more identified parameters,
selects a first radio channel of the plurality of detected radio channels such that the first radio channel corresponds to the best evaluation of the plurality of evaluations ranked by at least the subset of the one or more identified parameters, and
determines that a first radio of the plurality of radios corresponds to the first radio channel, and
sending the communication via the first radio channel using the first radio.

2. The method of claim 1, wherein the one or more identified parameters include a quality of connection parameter.

3. The method of claim 1, wherein the one or more identified parameters include a bandwidth parameter.

4. The method of claim 1, wherein the one or more identified parameters include a power consumption parameter.

5. The method of claim 1, wherein the one or more identified parameters include a cost-effectiveness parameter.

6. The method of claim 1, wherein the one or more identified parameters include a geolocation parameter.

7. The method of claim 1, wherein the one or more identified parameters include a virtual private network usage parameter.

8. The method of claim 1, wherein the one or more identified parameters include a biometric security parameter.

9. The method of claim 1, wherein detecting the plurality of radio channels through which the mobile device can transmit data includes polling for current radio information periodically based on a predetermined time interval.

10. An apparatus for providing a radio management center, the apparatus comprising:
a plurality of radios of a mobile device that can transmit data from the mobile device via a plurality of radio channels;
a memory of the mobile device that stores at least a set of radio settings that identify one or more parameters for evaluating the plurality of radios;
a user interface of the mobile device that receives a communication;
a processor of the mobile device that executes instructions stored in the memory of the mobile device, wherein execution of the instructions by the processor:
applies the set of radio settings to the detected radio channels,
generates a plurality of evaluations associated with the plurality of detected radio channels, wherein each evaluation of the plurality of evaluations assesses each radio channel of the plurality of detected radio channels based on at least a subset of the one or more identified parameters,
selects a first radio channel of the plurality of detected radio channels such that the first radio channel corresponds to the best evaluation of the plurality of evaluations ranked by at least the subset of the one or more identified parameters,
determines that a first radio of the plurality of radios corresponds to the first radio channel, and
sends the communication via the first radio channel using the first radio.

11. The apparatus of claim 10, wherein the one or more identified parameters include a quality of connection parameter.

12. The apparatus of claim 10, wherein the one or more identified parameters include a bandwidth parameter.

13. The apparatus of claim 10, wherein the one or more identified parameters include a power consumption parameter.

14. The apparatus of claim 10, wherein the one or more identified parameters include a cost-effectiveness parameter.

15. The apparatus of claim 10, wherein the one or more identified parameters include a geolocation parameter.

16. The apparatus of claim 10, wherein the one or more identified parameters include a virtual private network usage parameter.

17. The apparatus of claim 10, wherein the one or more identified parameters include a biometric security parameter.

18. The apparatus of claim 10, wherein execution of the instructions by the processor further polls for current radio information periodically based on a predetermined time interval, the current radio information identifying if each radio of the plurality of radios can transmit data from the mobile device.

19. A non-transitory computer-readable storage medium, having embodied thereon a program executable by a processor to perform a method for providing a radio management center, the method comprising:
storing a set of radio settings in memory of a mobile device, the mobile device including a plurality of radios, wherein the stored set of radio settings identifies one or more parameters for evaluating the plurality of radios;
receiving a communication via a user interface of the mobile device;
detecting a plurality of radio channels through which the mobile device can transmit data;
applying the stored set of radio settings to the plurality of detected radio channels;
generating a plurality of evaluations associated with the plurality of detected radio channels, wherein each evaluation of the plurality of evaluations assesses each radio channel of the plurality of detected radio channels based on at least a subset of the one or more identified parameters;
selecting a first radio channel of the plurality of detected radio channels such that the first radio channel corresponds to the best evaluation of the plurality of evaluations ranked by at least the subset of the one or more identified parameters;
determining that a first radio of the plurality of radios corresponds to the first radio channel; and
sending the communication via the first radio channel using the first radio.
